(19) United States
(12) Patent Application Publication
(10) Pub. No.: US 2013/0166424 A1
(43) Pub. Date: Jun. 27, 2013

(54) SYSTEM AND METHOD FOR SYSTEM INTEGRATION

(71) Applicants: Nitin Mahajan, Pune (IN); Gaurav Bhagwat, Pune (IN); Partha Chakraborty, Kolkata (IN); Gunda Lakshmi Narasimha Rao, Bangalore (IN); Sanjay Kumar Suryadevra, Pune (IN); Nandan Kaluskar, Pune (IN); Satyabrata Biswas, Kolkata (IN)

(72) Inventors: Nitin Mahajan, Pune (IN); Gaurav Bhagwat, Pune (IN); Partha Chakraborty, Kolkata (IN); Gunda Lakshmi Narasimha Rao, Bangalore (IN); Sanjay Kumar Suryadevra, Pune (IN); Nandan Kaluskar, Pune (IN); Satyabrata Biswas, Kolkata (IN)

(73) Assignee: INFOSYS LIMITED, Bangalore (IN)

(21) Appl. No.: 13/424,923

(22) Filed: Mar. 20, 2012

(30) Foreign Application Priority Data
Dec. 27, 2011 (IN) 4599/CHE/2011

(51) Int. Cl. G06Q 10/00

(52) U.S. Cl. 705/34

(57) ABSTRACT

The present invention relates to a system and method of integration among software components. The method allows integration between data corresponding to a first set of software components and a second set of software components. This method also involves exposing Application Program Interfaces (APIs) to a plurality of end user applications, wherein the APIs allow communication among the at least one end user application, the first set of software components and the second set of software components.

### RELATED APPLICATION DATA

This application claims priority to Indian Patent Application No. 4599/CHE/2011, filed Dec. 27, 2011, which is hereby incorporated by reference in its entirety.

### BACKGROUND

The present technique relates to the field of system integration. In particular, this invention relates to a. system and method of integration among customer care solutions.

Companies having customer facing teams use multiple online applications to handle different functions of customer support, for example, billing support, customer relationship management, product support, ordering support and resolving queries raised by customers, Each of the above mentioned functions of customer support are performed using individual online applications existing within a company. Users of the online applications are customer service representatives who communicate with customers of the company using multiple channels, for example, telephone, e-mail, chat and the like. Increasingly, there is a need for the customer service representatives to use information from multiple online applications to address functions of customer support. Usage of multiple online applications to retrieve information about a customer creates inefficiency in the customer service representatives team and increases time taken to perform customer support functions. The inefficiency leads to increase in key performance indicators like average call handling time and number of calls arising from the same customer.

Another disadvantage of using multiple online applications is that, increase in time taken by customer service representatives i.e., average call handling time to perform customer support functions not only leads to deteriorating productivity of customer facing teams but also poor customer experience.

Because the online applications used within a company are independent of each other, in order to leverage the functions offered by the individual online applications in new channels, tor example, mobile, interactive voice response, customer self-care and social networks, there exists a need for the online applications to work with each other, by sending and receiving information among each other.

In order to overcome the inefficiencies that arise by the use of individual online applications by customer service representatives and to leverage functions offered by individual online applications in multiple channels, integration between online applications is necessary for customer facing teams in a company.

### SUMMARY OF TILE INVENTION

The inefficiencies discussed above are overcome by the present invention. The system allows the customer service representative, to efficiently access information across all multiple online applications, using end user applications and the integration leverages the online applications to be available on channels like mobile, interactive voice response, customer self care and social networks,

The present invention relates to a system for integration between a first set of software components that include at least one of knowledge management component, a notification component and a customer profiling component and a second set of software components that include at least one of a customer relationship component, a billing component, an ordering component, a supplier component, a workflow management component and an issue tracking component. The integration module is configured to integrate data obtained from at least one of first set of software components and at least one of second set of software components. The presentation layer is configured to communicate with the integration module, wherein the presentation layer exposes one or more Application Program Interfaces (APIs) to the integration module, thereby allowing communication among at least one end user application, the at least one first set of software components, and the at least one second set of software components.

The present invention relates to a method which allows integration between data corresponding to a first set of software components and data corresponding to a second set of software components, the first set of software components comprises at least one of a knowledge management component, at least one notification component, and at least one customer profiling component; and the second set of software components comprises at least one of a customer relationship management platform, a billing component, an ordering component, a supplier component, a workflow management component and an issue tracking component. Also, exposing one or more Application Program Interfaces (APIs) to at least one end user application, wherein the APIs allow communication among the at least one end user application, the first set of software components, and the second set of software components.

### DRAWINGS

These and other features, aspects, and advantages of the present invention will be better understood when the following detailed description is read with reference to the accompanying drawings in which like characters represent like parts throughout the drawings, wherein:

FIG. 1 shows an environment in which the present invention can be practiced, in accordance with an embodiment of the present invention;

FIG. 2 is a block diagram of a system in which the present invention can be practiced, in accordance with another embodiment of the present invention;

FIG. 3 shows an environment in which the present invention can be practiced, in accordance with another embodiment of the present invention;

FIG. 4 is a flowchart describing a method, in accordance with an embodiment of the present invention; and

FIG. 5 illustrates a generalized example of a computing environment 500.

### DETAILED DESCRIPTION

The following description is the full and informative description of the best method and system presently contemplated for carrying out the present invention which is known to the inventors at the time of filing the patent application. Of course, many modifications and adaptations will be apparent to those skilled in the relevant arts in view of the following description in view of the accompanying drawings and the appended claims. While the system and method described herein are provided with a certain degree of specificity, the present technique may be implemented with either greater or lesser specificity, depending on the needs of the user. Further, some of the features of the present technique may be used to get an advantage without the corresponding use of other features described in the following paragraphs. As such, the present description should be considered as merely illustrative of the principles of the present technique and not in limitation thereof, since the present technique is defined solely by the claims.

Customer facing operations of a company include a part of operations which is dedicated to interact with customers, A “company” is an organization which sells, distributes or markets products or services. A “customer” is an individual who requires information about the company's products or services and requires assistance from a company's customer service representative. Examples of customer facing operations may include but not limited to troubleshooting customer premise equipment, resolving queries raised by customer and handling communications with the customers.

An application server is a software framework that acts as an environment for applications to execute; in particular it allows execution of procedures, scripts and routines,

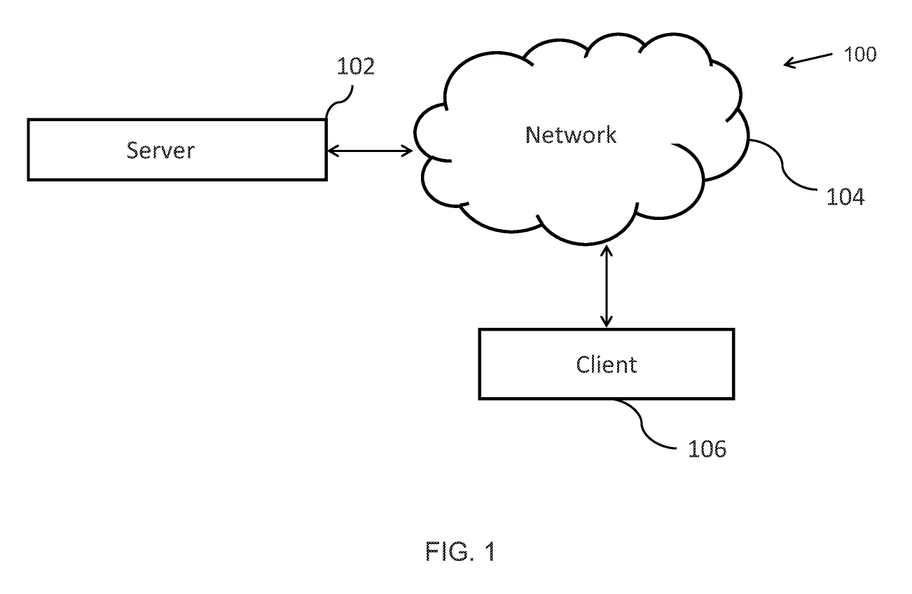

FIG. 1 shows an environment 100 in which the present invention can be practiced, in accordance with an embodiment of the present invention. Environment 100 includes a server 102, a communication network 104 and a client 106. Examples of server may include but not limited to application servers and web servers. Examples of client may include but not limited to desktop computers, laptops and smart phones. Examples of network may include but not limited to local area network (LAN), wide area network (WAN) and Internet,

The server 102 communicates with the client 106 over a network 104. In an embodiment of the system, the server 102 is an application server that stores all the applications and their corresponding information that belong to the company. The integration between a first set of software components and a second set of components is performed at the server 102 in an embodiment of the invention, the customer service representative uses the network 104 to access the applications hosted on the server 102 over an intranet within the company's premises. The applications hosted on the server 102 provide information to the customer service representative to carry out customer support functions.

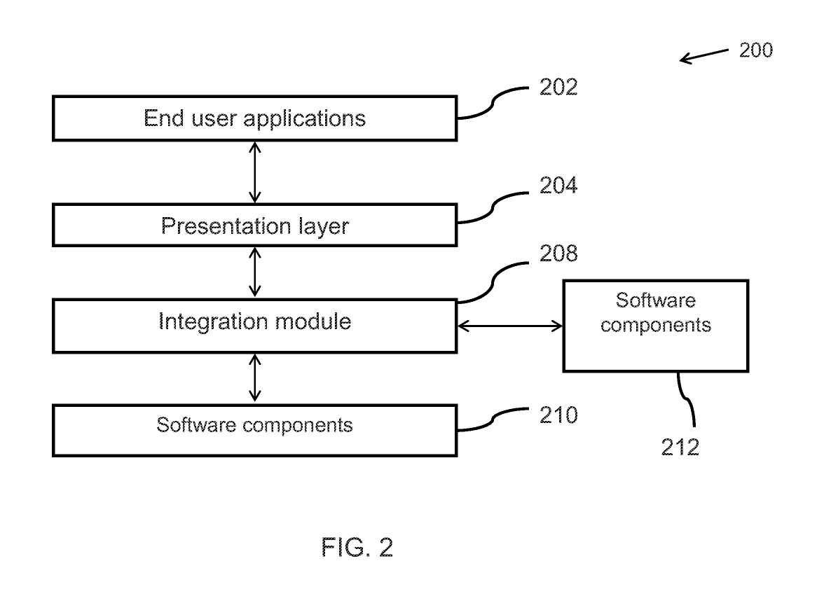

FIG. 2 is a block diagram of a system 200 in which the present invention can be practiced, in accordance with an embodiment of the present invention. The system is present on the server 102 includes end user applications 202, a presentation layer 204, an integration module 208, a first set of software components 210 and a second set of software components 212.

As shown in the block diagram, in accordance with an embodiment of the present invention, the system that is present on the server 102 includes a first set of software components 210, an example of first set of software components may include but not limited to a knowledge management component, a notification component, and a customer profiling component. The data from first set of software components integrate with data from a second set of software components 212 and this integration between data from the first and second set of software components is enabled by an integration module 208. Examples of second set of software components may include but not limited to customer relationship management component, a billing component, an ordering component and an issue tracking component.

The integration module 208 is configured to receive selected data fields from a first set of software components and a second set of software components. The integration module 208 creates a wrapper class which acts as a base class for the data received from the first and second set of software components. The wrapper class can be represented as a POJO (Plain Old Java Object) and can be stored in the memory of the application server or persistently.

The presentation layer 204 is uses the object of the wrapper class created earlier to communicate the integrated data to the end user applications 202. This is performed by the presentation layer 204 which is configured to accept requests from a variety of formats including HTML GET and POST, JSON ClavaScript Object Notation) and XML (Extensible Markup Language) using application programming interfaces (APIs) that are pre-defined. The presentation layer 204 is also configured to send responses to the end user applications 202 in a standard formats, some examples of standard formats may include but not limited to HTML and XML.

The end user applications 202 communicate with the presentation layer 204 by sending a request in at least one of the formats presentation layer 204 is configured to accept, mentioned above. An example of an end user application is a web application that provides all information about a customer in one screen to a customer service representative, the web application uses data from a customer profiling component which stores the usage data of a customer using an Internet service and the web application uses data from the billing component, Using the information from customer profiling component and the billing component, the web application is able to show the customer service representative information both the internet usage of the customer in this month and the amount of bill paid by the customer for the last month.

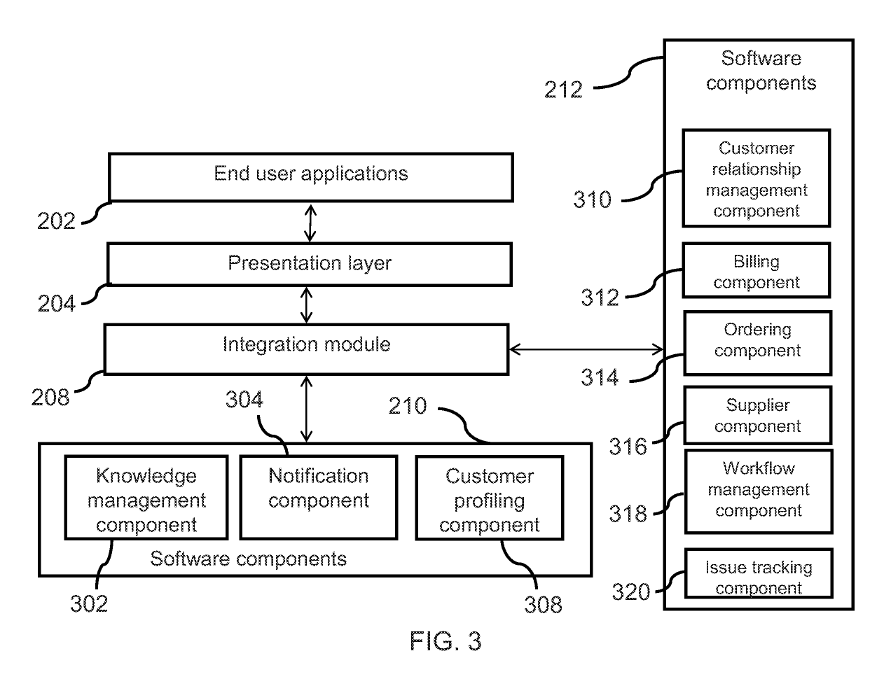

FIG. 3 is a block diagram of a system 300 in which the present invention can be practiced, in accordance with another embodiment of the present invention. The system is present on the server 102 includes end user applications 202, a presentation layer 204, an integration module 208, a first set of software components 210 and a second set of software components 212. The first set of software components 210 includes a knowledge management component 302, a notification component 304 and a customer profiling component 308. The second set of software components 212 include an issue tracking component 320, a workflow management component 318, a supplier component 316, an ordering component 314, a billing component 312, a customer relationship component 310.

In another embodiment of this invention, in the context of a company which is an internet service provider (ISP) as an example, a knowledge management component 302 is an application that is used for internal knowledge transfer among customer service representatives, certain problems occur at customer premises more often than others, the knowledge management component acts as an repository for such frequently occurring problems that are used by customer service representatives while answering customer calls that involve troubleshooting. The notification component 304 is an application used by customer service representatives to inform customers in advance about an outage due to maintenance activities in a particular locality. The customer profiling component 308 is an application used by customer service representatives to view the internet usage history of a customer. The customer relationship component 310 is typically customer relationship management (CRM) software that is implemented and used for managing an interim service provider's interactions with a customer for purposes of marketing, sales and client prospects, The CRM software is used for automating the above mentioned activities. The billing component 312 is an application used by the interact service provider to generate and send bills to its customers. The billing component 312 also maintains the status of payment for bills generated. The ordering component 314 is an application used by an internet service provider for tracking customer orders tor product (customer premise equipment) delivery and shipping of products. The supplier component 316 is an application for supplier relationship management which is used by an internet service provider for managing supplies, for example, office supplies and equipment required for meeting business goals. The workflow management component 318 is an application that is used by an internet service provider to define and manage a series of tasks between customer service representatives and other members of the company in an automated manner. The workflow management component uses stores the series of tasks and processes followed within an organization in the form of business process markup language (BPML). The issue tracking component 320 is an application that is used by customers of internet service provider to raise queries to the response to the queries are entered by the customer service representatives in the issue tracking component.

The interactions between the first set of software components 210, the second set of software components 212, the integration module 208, presentation layer 204 and the end user applications 202 is described above.

In another embodiment of the invention, the communication among at least one end user application, the first set of software components and the first set of software components can be configured to communicate by using enterprise service bus model.

In another embodiment of the invention, the components present in the first of software components 210 may communicate among each other by using the integration module 208.

In another embodiment of the invention, the components present in the second set of software components 212 may communicate among each other by using the integration module 208.

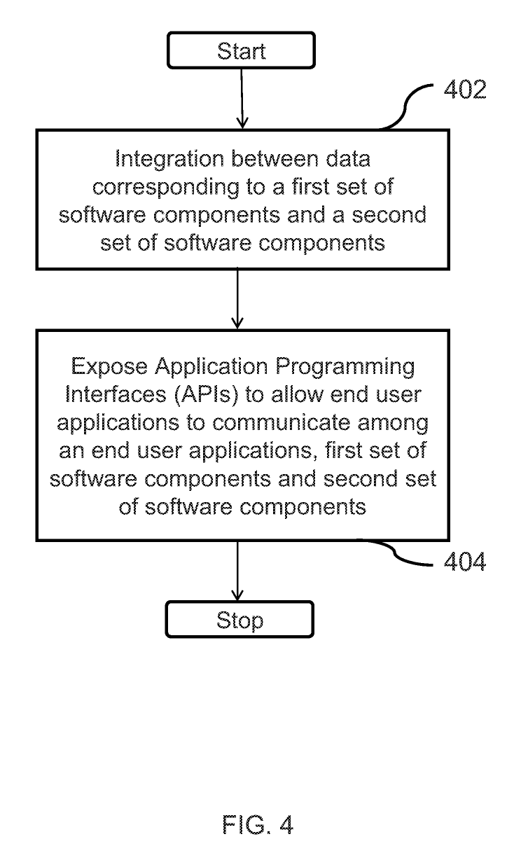

FIG. 4 is a flowchart describing a method, in accordance with an embodiment of the present invention.

At step 402, integration between data corresponding to a first set of software components and data corresponding to a second set of software components is performed. The first set of software components includes a knowledge management component, a notification component and a customer profiling component. The second set of software components include a customer relationship management component, a billing component, an ordering component, a supplier component, a workflow component and an issue tracking component. The examples and functions of the first and second set of software components are described earlier.

At step 404, the application programming interfaces (APIs) that are pre-defined are exposed to the end user applications allowing communication among at least one end user application, the first set of software components and the second set of software components. The application programming interfaces use pre-defined formats for communication that allow end user applications to send and receive data. The series of steps involved in communication among the end user applications, the first set of software components and the second set of software components is described earlier.

### Exemplary Computing Environment

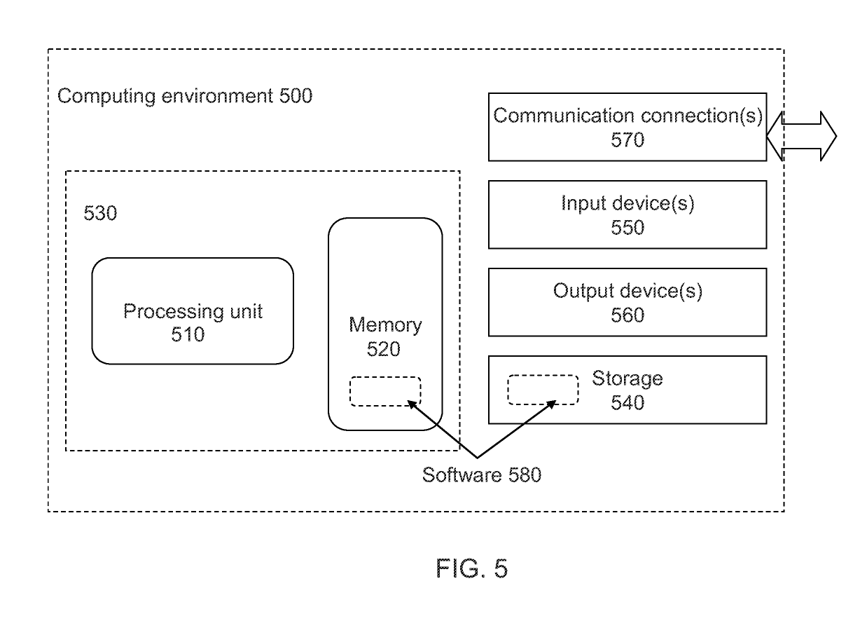

One or more of the above-described techniques can be implemented in or involve one or more computer systems. FIG. 5 illustrates a generalized example of a computing environment 500. The computing environment 500 is not intended to suggest any limitation as to scope of use or functionality of described embodiments.

With reference to FIG. 5, the computing environment 500 includes at least one processing unit 510 and memory 520. In FIG. 5, this most basic configuration 530 is included within a dashed line, The processing unit 510 executes computer-executable instructions and may be a real or a virtual processor. In a multi-processing system, multiple processing units execute computer-executable instructions to increase processing power. The memory 520 may be volatile memory (e.g., registers, cache, RAM), non-volatile memory (e.g., RUM, EEPROM, flash memory, etc.), or some combination of the two. In some embodiments, the memory 520 stores software 580 implementing described techniques.

A computing environment may have additional features. For example, the computing environment 500 includes storage 540, one or more input devices 550, one or more output devices 560, and one or more communication connections 570. An interconnection mechanism (not shown) such as a bus, controller, or network interconnects the components of the computing environment 500. Typically, operating system software (not shown) provides an operating environment for other software executing in the computing environment 500, and coordinates activities of the components of the computing environment 500.

The storage 540 may be removable or non-removable, and includes magnetic disks, magnetic tapes or cassettes, CD-ROMs, CD-RWs, DVDs, or any other medium which can be used to store information and which can be accessed within the computing environment 500. In some embodiments, the storage 540 stores instructions for the software 580,

The input device(s) 550 may be a touch input device such as a keyboard, mouse, pen, trackball, touch screen, or game controller, a voice input device, a scanning device, a digital camera, or another device that provides input to the computing environment 500. The output device(s) 560 may be a display, printer, speaker, or another device that provides output from the computing environment 500.

The communication connection(s) 570 enable communication over a communication medium to another computing entity. The communication medium conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Implementations can be described in the general context of computer-readable media. Computer-readable media are any available media that can be accessed within a computing environment. By way of example, and not limitation, within the computing environment 500, computer-readable media include memory 520, storage 540, communication media, and combinations of any of the above.

Having described and illustrated the principles of our invention with reference to described embodiments, it will be recognized that the described embodiments can be modified in arrangement and detail without departing from such principles. It should be understood that the programs, processes, or methods described herein are not related or limited to any particular type of computing environment, unless indicated otherwise. Various types of general purpose or specialized computing environments may be used with or perform operations in accordance with the teachings described herein. Elements of the described embodiments shown in software may be implemented in hardware and vice versa.

As will be appreciated by those ordinary skilled in the art, the foregoing example, demonstrations, and method steps may be implemented by suitable code on a processor base system, such as general purpose or special purpose computer. It should also be noted that different implementations of the present technique may perform some or all the steps described herein in different orders or substantially concurrently, that is, in parallel. Furthermore, the functions may be implemented in a variety of programming languages. Such code, as will be appreciated by those of ordinary skilled in the art, may be stored or adapted for storage in one or more tangible machine readable media, such as on memory chips, local or remote hard disks, optical disks or other media, which may be accessed by a processor based system to execute the stored code. Note that the tangible media may comprise paper or another suitable medium upon which the instructions are printed. For instance, the instructions may be electronically captured via optical scanning of the paper or other medium, then compiled, interpreted or otherwise processed in a suitable manner if necessary, and then stored in a computer memory.

The following description is presented to enable a person of ordinary skill in the art to make and use the invention and is provided in the context of the requirement for a obtaining a. patent. The present description is the best presently-contemplated method for carrying out the present invention. Various modifications to the preferred embodiment will be readily apparent to those skilled in the art and the generic principles of the present invention may be applied to other embodiments, and some features of the present invention may be used without the corresponding use of other features. Accordingly, the present invention is not intended to be limited to the embodiment shown but is to be accorded the widest scope consistent with the principles and features described herein.

1. A computer system for providing access to multiple sets of software components through a unified interface, the computer system comprising:
one or more processors; and
one or more memories operatively coupled to at least one of the one or more processors and having instructions stored thereon that, when executed by at least one of the one or more processors, cause at least one of the one or more processors to:
integrate data obtained from at least two sets of software components by creating a wrapper class to store the obtained data in a wrapper object;
receive a request to access data from the at least two sets of software components via one or more Application Programming Interfaces, wherein:
a first set of the at least two sets of software components comprises at least one of a knowledge management component, a notification component, and a customer profiling component, and
a second set of the at least two sets of software components comprises at least one of a customer relationship management component, a billing component, an ordering component, a supplier component, a workflow management component and an issue tracking component;
filter the data in the wrapper object according to a set of parameters received with the request which specify the data that is being requested from the at least two sets of software components; and
transmit the filtered wrapper object data to one or more users via the one or more Application Programming Interfaces.

2. The system of claim 1, wherein the knowledge management component is configured to store predefined information that allows a customer to diagnose problems associated with at least one of a set-top box, a mobile phone, and a fixed line telephone.

3. The system of claim 1, wherein the notification component comprises an alert module configured to send at least one of on-demand alerts and periodic alerts to a customer.

4. The system of claim 1, wherein the customer profiling component is configured to store customer usage information associated with at least one of a set-top box, a mobile phone, and a fixed line telephone.

5. The system of claim 1, wherein the customer relationship management component comprises customer profile information.

6. The system of claim 1, wherein the billing component is configured to store billing information associated with at least one customer.

7. The system of claim 1, wherein the ordering component is configured to store order information associated with at least one customer.

8. The system of claim 1, wherein the supplier component is configured to store information associated with at least one supplier.

9. The system of claim 1, wherein the data integration comprises exchanging information between the first set of software components and the second set of software components through the wrapper class.

10. The system of claim 1, wherein the issue tracking component is configured to store trouble ticket information associated with at least one customer.

11. The system of claim 1, wherein the workflow management component is configured to store a sequence of operations followed within an organization.

12. A method of providing access to multiple sets of software components through a unified interface by one or more computing devices, comprising:
integrating, by at least one of the one or more computing devices, data obtained from at least two sets of software components by creating a wrapper class to store the obtained data in a wrapper object;
receiving, by at least one of the one or more computing devices, a request to access data from the at least two sets of software components via one or more Application Programming Interfaces, wherein:
a first set of the at least two sets of software components comprises at least one of a knowledge management component, a notification component, and a customer profiling component,
a second set of the at least two sets of software components comprises at least one of a customer relationship management component, a billing component, an ordering component, a supplier component, a workflow management component and an issue tracking component;
filtering, by at least one of the one or more computing devices, the data in the wrapper object according to a set of parameters received with the request which specify the data that is being requested from the at least two sets of software components; and
transmitting, by at least one of the one or more computing devices, the filtered wrapper object data to one or more users via the one or more Application Programming Interfaces.

13. The method of claim 12, wherein the knowledge management component receives data from a at least one end user application to diagnose a problem associated with at least one of a set-top box, a mobile phone, and a fixed line telephone.

14. The method of claim 12, wherein the method further comprises: sending at least one of an on-demand alert and a periodic alert to the customer.

15. The method of claim 12, wherein the customer profiling component receives data from at least one end user application to store usage information associated with at least one of a set-top box, a mobile phone, and a fixed line telephone.

16. The method of claim 12, wherein the billing component receives data from at least one end user application to store information associated with at least one customer.

17. The method of claim 12, wherein the ordering component receives information from at least one end user application to store order information associated with at least one customer.

18. The method of claim 12, wherein the supplier component receives information from at least one end user application to store information associated with at least one supplier.

19. The method of claim 12, wherein integrating data comprises context passing between the first set of software components and the second set of software components through the wrapper class.

20. The method of claim 12, wherein the issue tracking component receives information from at least one end user application to store trouble ticket information associated with at least one customer.

21. The method of claim 12, wherein the workflow management component receives information from at least one end user application to store a sequence of operations followed within an organization.

22. At least one non-transitory computer-readable medium storing computer-readable instructions for providing access to multiple sets of software components through a unified interface by one or more computing devices that, when executed by at least one of the one or more computing devices, cause at least one of the one or more computing devices to:
integrate data obtained from at least two sets of software components by creating a wrapper class to store the obtained data in a wrapper object;
receive a request to access data from the at least two sets of software components via one or more Application Programming Interfaces, wherein:
a first set of the at least two sets of software components comprises at least one of a knowledge management component, at least one a notification component, and a customer profiling component, and
a second set of the at least two sets of software components comprises at least one of a customer relationship management component, a billing component, an ordering component, a supplier component, a workflow management component and an issue tracking component;
filter the data in the wrapper object according to a set of parameters received with the request which specify the data that is being requested from the at least two sets of software components; and
transmit the filtered wrapper object data to one or more users via the one or more Application Programming Interfaces.
